(19) United States
(12) Patent Application Publication
(10) Pub. No.: US 2020/0108656 A1
(43) Pub. Date: Apr. 9, 2020

(54) Adjustment device capable of automatically reconciling paint detection color effect

(71) Applicant: Hao Tong, Yuyao City (CN)

(72) Inventor: Hao Tong, Yuyao City (CN)

(21) Appl. No.: 16/703,838

(22) Filed: Dec. 4, 2019

(30) Foreign Application Priority Data
Aug. 27, 2019 (CN) 2019107984150

(51) Int. Cl. B44D 3/00; B44D 3/08

(52) U.S. Cl. CPC B44D 3/003; B44D 3/08

(57) ABSTRACT

The invention discloses an adjusting device capable of automatically reconciling a paint to detect a color effect, comprising a base, a support, a top body and an auxiliary body. The support body and the auxiliary body are fixed on the top surface of the base. A support body is located on the left side of the auxiliary body, and the top body is fixed on the top surface of the auxiliary body. The support body is provided with two upwardly-opening storage chambers, and the two storage chambers can be stored in For paints of different colors, the top surface of the base can be placed with a reconciliation barrel. The reconciliation barrel is provided with a reconciliation cavity with an upward opening, and a connection cavity is provided on the lower side of the storage cavity. It can be more stable and uniform, and can prevent the paint from drying out and wasting. It can also continuously detect the color during the blending process, which can make the color of the paint more accurate.

### CROSS-REFERENCES TO RELATED APPLICATIONS

The present application claims priority from Chinese application No. 2019107984150 filed on Aug. 27, 2019 which is hereby incorporated by reference in its entirety.

### TECHNICAL FIELD

When decorating a house, paint is used, and in paint, not all colors of paint can be purchased directly. Many colors need to be blended by manual stirring to achieve the expected color standard, but the color of the paint blended by ordinary workers is often There is a big difference between the color and the design. The biggest problem is that during the blending process, the manual addition of paint cannot be accurately controlled, and manual mixing or mixing with a manual control stirring gun cannot evenly blend the paint, making the paint During the painting process, the color on the wall is not uniform. In addition, it is impossible to accurately detect whether the paint meets the standard after the paint is blended, which will usually force customers to lower the standard.

### CONTENT OF THE INVENTION

The purpose of the present invention is to provide an adjusting device capable of automatically reconciling the color effect of paint detection, which is used to overcome the above defects in the prior art.

According to an embodiment of the present invention, an adjustment device capable of automatically reconciling paint detection color effects includes a base, a support, a top, and an auxiliary body, and the support and the auxiliary body are fixed on a top surface of the base. The support body is located on the left side of the auxiliary body, and the top body is fixed on the top surface of the auxiliary body. The support body is provided with two upwardly-opening storage chambers, and two storage chambers Different colors of paint can be stored. The top surface of the base can be placed with a reconciliation barrel. The reconciliation barrel is provided with a reconciliation cavity with an upward opening. A connection cavity is provided on the lower side of the storage cavity. There is a discharge mechanism capable of discharging the paint in the storage cavity into the blending cavity and keeping the paint at a normal temperature to prevent the paint from drying out. The support body is provided with a sliding cavity opening to the right, and a left wall of the sliding cavity is provided. A support plate is provided for sliding up and down, and a vertical shaft for stirring and blending paint is provided on the lower side of the support plate, and a lifting mechanism for controlling the support plate to drive the vertical shaft to move up and down is provided in the sliding cavity. Top of the base A fixed box is fixedly installed on the top surface of the fixed box, and a detection plate for detecting the color of paint is fixed on the upper side of the detection plate. A turntable and a brush pen are provided on the upper side of the detection plate. The brush pen moves downward to receive a pneumatic mechanism for taking paint, the auxiliary body is provided with a cleaning mechanism capable of cleaning the paint on the surface of the detection board, a belt cavity is provided in the top body, and a controllable chamber is provided in the belt cavity. The turntable drives the brush pen to rotate and the cleaning mechanism to operate and clean the power mechanism.

In a further technical solution, the discharge mechanism includes a control valve connected to a lower side of the storage chamber, and a discharge pipe is connected to a lower side of the control valve, and the downward extension part of the discharge pipe extends into the connection chamber. Inside, the drain pipe extends to the right to the outside and is located above the reconciliation cavity. A thermal insulation layer is fixed on the bottom wall of the connection cavity, and a closed cover is installed on the upper side of the storage cavity.

In a further technical solution, the lifting mechanism includes a first motor fixedly mounted on a top wall of the sliding cavity, a bottom surface of the first motor is dynamically connected with a first screw, and the first screw extends downwardly and penetrates the first screw. The support plate is rotatably matched with the bottom wall of the sliding cavity, and the first screw is screwed with the support plate.

In a further technical solution, a second motor is embedded in the inner wall of the support plate, the top surface of the vertical shaft is dynamically connected to the second motor, and six sets of uniform arrangement are fixed on the outer periphery of the vertical shaft. Stirring rod.

In a further technical solution, a right side surface of the support body is hingedly provided with a first hinge rod, a spring cavity opening to the right is provided in the first hinge rod, and a top surface of the support plate is hinged with a second hinge A straight rod is fixed on the left side of the second articulated rod, the left extending portion of the straight rod extends into the spring cavity, and the left side of the straight rod and the left side of the spring cavity A spring is fixedly installed between the walls.

In a further technical solution, the pneumatic mechanism includes a pneumatic slide rail fixed on the right side surface of the turntable, the clamping block is slidably provided on the right side surface of the pneumatic slide rail, and the brush pen is clamped In the clamp block, a cylinder is fixed on the top surface of the turntable, and an air outlet pipe and an intake pipe are installed between the cylinder and the clamp block.

In a further technical solution, the cleaning mechanism includes a connecting plate, and a second screw, a pushing rod and a cleaning rod are fixedly arranged on the left side of the connecting plate, the second screw is located on the upper side of the pushing rod, and the pushing A rod is located on the upper side of the cleaning rod, a gear cavity, a drainage cavity and a through cavity are provided in the auxiliary body, the gear cavity is located on the upper side of the drainage cavity, and the drainage cavity is on the upper side of the through cavity A cleaning liquid is provided in the drainage chamber, and a screw sleeve is provided in the inner wall of the auxiliary body. The screw sleeve extends to the left into the gear cavity, and the second screw extends to the left. Through the screw sleeve, a square pillar is fixed on the left side of the screw sleeve, and the square pillar extends to the left to pass through the auxiliary body. The square pillar and the inner wall of the auxiliary body slide to fit. The second screw thread cooperates with the screw sleeve, the leftward extension of the push rod extends into the drainage chamber, and a piston is fixed on the left side of the push rod, and the left side of the drainage chamber A damping valve is installed on the side, and a nozzle is connected on the left side of the damping valve. The extension part extends outside and is located above the detection plate, the cleaning rod extends to the left into the through cavity, and the bottom surface of the cleaning rod is fixed with brushes, and the through cavity is left and right open, A jacket is fixed on the inner wall of the through cavity, the cleaning rod passes through the jacket, and the cleaning rod and the jacket are slidingly fitted.

In a further technical solution, a liquid storage chamber is provided on the rear side of the liquid discharge chamber, and the liquid storage chamber contains a cleaning liquid. A front side of the liquid storage chamber is connected with a check valve, and the check valve is connected with the check valve. A connection pipe is connected between the drainage chambers.

In a further technical solution, the power mechanism includes a third motor fixedly embedded in the inner wall of the top body, and a motor shaft is dynamically connected to the upper and lower sides of the third motor, which is located on the bottom surface of the motor shaft on the lower side. It is fixedly connected to the top surface of the turntable, and the axially extending portion of the motor on the upper side extends into the belt cavity, and a first pulley is fixed on the top surface of the motor shaft. A rotation shaft is rotatably provided on the bottom wall, and a second pulley is fixed on the top surface of the rotation shaft. A belt is installed between the second pulley and the first pulley, and the rotation axis extends downward. It partially penetrates the inner wall of the top body and the auxiliary body, and extends into the gear cavity, and a bottom bevel gear is fixed on the bottom surface of the rotating shaft, and the screw sleeve in the gear cavity A second bevel gear is fixed on the outer periphery, and the second bevel gear meshes with the first bevel gear.

In a further technical solution, a waste liquid cavity with an upward opening is provided in the fixed box.

The beneficial effect of the present invention is that the present invention can make the paint more stable and uniform when blending colors, and can prevent the paint from drying out and wasting. It can also continuously detect the color during the blending process, which can make the color accuracy of the paint more accurate. High, of which, the discharge mechanism can control the addition of two different colors of paint during the blending process through the control valve, so that the blending time is shorter and the blending accuracy is higher. After the lifting mechanism completes the paint mixing and reconciliation, the power mechanism can drive the brush to above the reconciliation cavity, and the pneumatic mechanism can control the brush to pick up the paint. The mechanism can clean the test paint on the surface of the test board.

### BRIEF DESCRIPTION OF THE DRAWINGS

FIG. 1 is a schematic diagram of the internal overall structure of the present invention;

FIG. 2 is a partial schematic view in the direction A-A in FIG. 1 of the present invention;

FIG. 3 is an enlarged schematic view of B in FIG. 1 of the present invention;

FIG. 4 is an enlarged schematic view of a position C in FIG. 1 of the present invention.

### DETAILED DESCRIPTION OF THE INVENTION

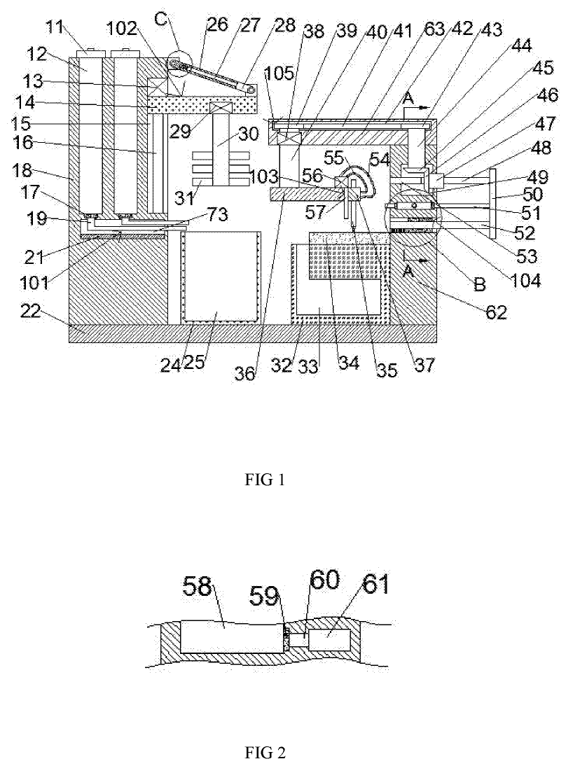

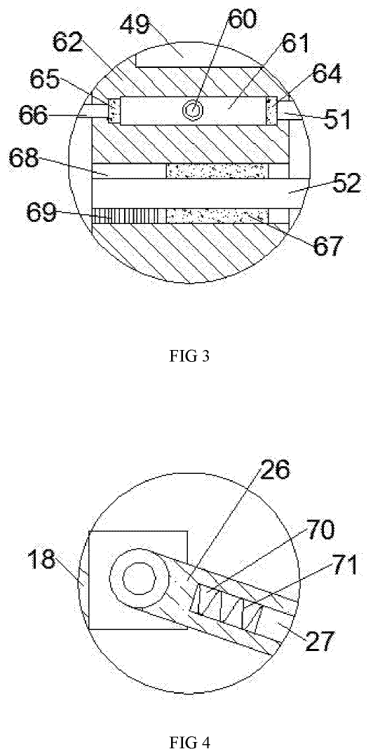

The present invention is described in detail below with reference to FIGS. 1-4. For convenience of description, the orientations described below are defined as follows: the up-down, left-right, front-back direction described below is consistent with the up-down, left-right, front-back direction of the projection relationship of FIG. 1 itself

Referring to FIGS. 1-4, an adjusting device capable of automatically blending paint detection color effects according to an embodiment of the present invention includes a base 22, a support body 18, a top body 63, and an auxiliary body 62. The support body 18 and the An auxiliary body 62 is fixed on the top surface of the base 22, the support body 18 is located on the left side of the auxiliary body 62, and the top body 63 is fixed on the top surface of the auxiliary body 62. The support body There are two storage chambers 12 opened upward in 18, two different storage chambers 12 can store paints of different colors, the top surface of the base 22 can be placed with a blending barrel 24, and the blending barrel 24 is provided with A reconciliation cavity 25 with an upward opening, and a connection cavity 73 is provided on the lower side of the storage cavity 12. The connection cavity 73 is provided with a paint that can discharge the paint in the storage cavity 12 into the reconciliation cavity 25. A discharge mechanism 101 for preventing paint from drying at normal temperature, the support body 18 is provided with a sliding cavity 15 opening to the right, and a support plate 14 is slid up and down on the left wall of the sliding cavity 15. A vertical shaft 30 is provided on the side to be used for stirring and blending the paint. The sliding cavity 15 is provided with a controllable booth. The support plate 14 drives the lifting mechanism 102 for the vertical shaft 30 to move up and down. A fixed box 32 is fixed on the top surface of the base 22, and a detection plate 34 for fixing the color of the paint is fixed on the top surface of the fixed box 32. The upper side of the detection plate 34 is provided with a turntable 36 and a brush pen 35, and a right side of the turntable 36 is provided with a pneumatic mechanism 103 that can control the brush pen 35 to move downward to pick up paint, and the auxiliary body 62 There is a cleaning mechanism 104 inside which can clean the paint on the surface of the detection plate 34. A belt cavity 42 is opened in the top body 63. The belt cavity 42 is provided with a controllable turntable 36 to drive the brush pen 35 to rotate. And the cleaning mechanism 104 operates a cleaning power mechanism 105.

In addition, in one embodiment, the discharge mechanism 101 includes a control valve 17 connected to a lower side of the storage chamber 12, and a discharge pipe 19 is connected to a lower side of the control valve 17. The lower extension portion extends into the connection cavity 73, the discharge pipe 19 extends to the right to the outside and is located above the reconciliation cavity 25. A heat insulation layer 21 is fixed on the bottom wall of the connection cavity 73. An upper cover 11 is installed on the upper side of the storage chamber 12, and the paint in the storage chamber 12 can be controlled to be discharged through the control valve 17, and discharged into the reconciliation chamber 25 through the discharge pipe 19. The heat insulation layer 21 can prevent the paint in the discharge pipe 19 from drying out, and the paint in the storage chamber 12 can be closed by the closing cover 11 to prevent dust from entering.

In addition, in one embodiment, the lifting mechanism 102 includes a first motor 13 fixed on the top wall of the sliding cavity 15, and a first screw 16 is dynamically connected to the bottom surface of the first motor 13. A downward extension portion of the first screw 16 penetrates the support plate 14 and is rotationally matched with the bottom wall of the sliding cavity 15. The first screw 16 is screw-fitted with the support plate 14 and passes through the first motor 13. The operation allows the support plate 14 to move up and down, when it is necessary to stir and mix the paint, it moves down, and when it needs to detect the color of the paint, it moves up.

In addition, in an embodiment, a second motor 29 is embedded in the inner wall of the support plate 14, and the top surface of the vertical shaft 30 is dynamically connected to the second motor 29. Six groups of uniformly arranged stirring rods 31 are fixed. Through the operation of the second motor 29, the vertical shaft 30 can drive the stirring rods 31 to rotate, and the stirring rods 31 can be used to stir and mix paint.

In addition, in an embodiment, a right side surface of the support body 18 is hingedly provided with a first hinge rod 26, and a spring cavity 70 opening to the right is provided in the first hinge rod 26. The top surface is hingedly provided with a second hinge rod 28, and a left side surface of the second hinge rod 28 is fixedly provided with a straight rod 27, and the straight rod 27 extends to the left into the spring cavity 70, and the A spring 71 is fixedly installed between the left side surface of the straight rod 27 and the left wall of the spring cavity 70. Through the first hinge rod 26, the spring 71, the straight rod 27, and the second hinge rod The combined action of 28 can make the support plate 14 more stable, and thus can make the stirring rod 31 more uniform during the stirring process.

In addition, in one embodiment, the pneumatic mechanism 103 includes a pneumatic slide rail 57 fixed on the right side of the turntable 36, and the clamping block 37 is slidably provided on the right side of the pneumatic slide rail 57. The brush pen 35 is clamped in the clamp block 37. A cylinder 56 is fixed on the top surface of the turntable 36. An air outlet pipe 55 and an inlet pipe are connected between the cylinder 56 and the clamp block 37. The air pipe 54 can cause the clamp block 37 to drive the brush pen 35 to move up and down through the operation control of the air cylinder 56, and when the paint needs to be taken in, it moves down, and when it needs to be tested, it moves up.

In addition, in one embodiment, the cleaning mechanism 104 includes a connection plate 50. A second screw 48, a pushing rod 51, and a cleaning rod 52 are fixedly located on the left side of the connection plate 50. The second screw 48 is located at The upper side of the push rod 51 is located on the upper side of the cleaning rod 52. The auxiliary body 62 is provided with a gear cavity 49, a drainage cavity 61 and a through cavity 68, and the gear cavity 49 is located at The upper side of the drainage chamber 61 is located on the upper side of the through chamber 68. The drainage chamber 61 is provided with a cleaning liquid. The inner wall of the auxiliary body 62 is provided with a screw sleeve 47. The left extension of the screw sleeve 47 extends into the gear cavity 49, the left extension of the second screw 48 penetrates the screw sleeve 47, and a square post 53 is fixed on the left side of the screw sleeve 47. The square pillar 53 extends to the left part of the pipe through the auxiliary body 62, the square pillar 53 and the inner wall of the auxiliary body 62 are slidingly fitted, and the second screw 48 is mated with the screw sleeve 47, so that The pushing rod 51 extends to the left into the drainage chamber 61, and a piston 64 is fixed on the left side of the pushing rod 51. The left side of the drainage chamber 61 communicates with each other. Equipped with a damping valve 65, the left side of the damping valve 65 is connected with a nozzle 66, the nozzle 66 extends to the left to extend outside, is located above the detection plate 34, and the cleaning rod 52 is to the left The extending portion extends into the through cavity 68, and a brush 69 is fixed on the bottom surface of the cleaning rod 52. The through cavity 68 is open on the left and right, and a jacket 67 is fixed on the inner wall of the through cavity 68. The cleaning rod 52 penetrates the jacket 67, and the cleaning rod 52 slides and cooperates with the jacket 67. Through the rotation of the screw sleeve 47, the second screw 48 can drive the connecting plate 50 to the left The movement can move the pushing rod 51 and the cleaning rod 52 to the left at the same time, and when the pushing rod 51 moves to the left, the cleaning liquid in the drainage chamber 61 can pass through the nozzle 66 When discharged to the top surface of the detection plate 34, when the cleaning lever 52 is moved to the left, the hair brush 69 may be used to scrub the top surface of the detection plate 34.

In addition, in one embodiment, a liquid storage chamber 58 is opened at the rear side of the drainage chamber 61, the liquid storage chamber 58 contains a cleaning liquid, and a front side of the liquid storage chamber 58 is connected with a check valve. 59. A connection pipe 60 is installed between the one-way valve 59 and the drain chamber 61. When the cleaning liquid in the drain chamber 61 is emptied, and the push rod 51 drives the piston 64 to When moving to the right, the cleaning liquid in the liquid storage chamber 58 can enter the liquid discharge chamber 61 through the connection pipe 60.

In addition, in one embodiment, the power mechanism 105 includes a third motor 38 embedded in the inner wall of the top body 63, and motor shafts 40 are dynamically connected to the upper and lower sides of the third motor 38. The bottom surface of the motor shaft 40 on the lower side is fixedly connected to the top surface of the turntable 36, and the upwardly extending portion of the motor shaft 40 on the upper side projects into the belt cavity 42, and the top surface of the motor shaft 40 is fixed. A first pulley 39 is provided. A rotating shaft 44 is rotatably provided on the bottom wall of the belt cavity 42. A second pulley 43 is fixed on the top surface of the rotating shaft 44. A belt 41 is installed between the first pulleys 39, and the downwardly extending portion of the rotating shaft 44 penetrates the inner walls of the top body 63 and the auxiliary body 62 and extends into the gear cavity 49, and the A first bevel gear 45 is fixed on the bottom surface of the rotation shaft 44, and a second bevel gear 46 is fixed on the outer periphery of the screw sleeve 47 located in the gear cavity 49. A bevel gear 45 meshes, and the motor shaft 40 can be rotated by the operation of the third motor 38, so that the turntable 36 can drive the The brush pen 35 rotates. When it is necessary to pick up paint, the turntable 36 rotates so that the brush pen 35 is located above the reconciliation cavity 25. When the paint color needs to be detected, the turntable 36 rotates so that the brush pen 35 is located Above the detection plate 34, the rotation of the motor shaft 40 can simultaneously drive the belt 41, so that the rotating shaft 44 can drive the screw sleeve 47 to rotate.

In addition, in one embodiment, the fixed tank 32 is provided with a waste liquid cavity 33 with an upward opening, and the waste liquid cavity 33 can be used to collect the cleaned waste liquid.

When in use, the paint in the discharge storage chamber 12 can be controlled by the control valve 17 and discharged into the reconciliation chamber 25 through the discharge pipe 19. The paint in the discharge pipe 19 can be prevented from drying out by the heat insulation layer 21, and can be closed by the closure lid 11. The paint in the storage chamber 12 prevents dust from entering. By the operation of the first motor 13, the support plate 14 can be moved up and down. When the paint needs to be blended and mixed, it can be moved down. When the color of the paint needs to be detected, it can be moved up. The operation of the two motors 29 can cause the vertical shaft 30 to drive the stirring rod 31 to rotate, so that the stirring rod 31 can stir and blend the paint. Through the operation control of the air cylinder 56, the clamping block 37 can be driven to move the brush pen 35 up and down. When painting, move down. When testing is needed, move up. The motor shaft 40 can be rotated by the operation of the third motor 38, and the turntable 36 can drive the brush pen 35 to rotate. When the paint needs to be stained, the turntable 36 Rotate the brush pen 35 above the reconciliation cavity 25. When the paint color needs to be detected, the turntable 36 is rotated to place the brush pen 35 above the detection plate 34. The rotation of the motor shaft 40 can simultaneously drive the belt 41, so that the rotation shaft 44 can be driven. The sleeve 47 rotates, and through the rotation of the screw sleeve 47, the second screw 48 can drive the connecting plate 50 to move to the left, so that the push rod 51 and the cleaning rod 52 can be moved to the left at the same time. When the push rod 51 is moved to the left, the The cleaning liquid in the drainage chamber 61 is discharged to the top surface of the detection plate 34 through the nozzle 66. When the cleaning rod 52 is moved to the left, the top surface of the detection plate 34 can be scrubbed by a brush 69. When the liquid is evacuated, and the piston 64 is moved to the right by the push rod 51, the cleaning liquid in the liquid storage chamber 58 can enter the liquid discharge chamber 61 through the connecting pipe 60.

The beneficial effect of the present invention is that the present invention can make the paint more stable and uniform when blending colors, and can prevent the paint from drying out and wasting. It can also continuously detect the color during the blending process, which can make the color accuracy of the paint more accurate. High, of which, the discharge mechanism can control the addition of two different colors of paint during the blending process through the control valve, so that the blending time is shorter and the blending accuracy is higher. After the lifting mechanism completes the paint mixing and reconciliation, the power mechanism can drive the brush to above the reconciliation cavity, and the pneumatic mechanism can control the brush to pick up the paint. The mechanism can clean the test paint on the surface of the test board.

Those skilled in the art can clearly understand that various modifications to the above embodiments can be made without departing from the overall spirit and concept of the present invention. They all fall within the protection scope of the present invention. The protection scheme of the present invention is subject to the claims attached to the present invention.

1. An adjusting device capable of automatically reconciling the color effect of paint detection, comprising a base, a support, a top body and an auxiliary body, characterized in that the support and the auxiliary body are fixed on the top surface of the base. A support body is located on the left side of the auxiliary body, and the top body is fixed on the top surface of the auxiliary body. The support body is provided with two upwardly-opening storage chambers, and the two storage chambers can be stored in For paints of different colors, the top surface of the base can be placed with a reconciliation barrel. The reconciliation barrel is provided with a reconciliation cavity with an upward opening. A connection cavity is provided on the lower side of the storage cavity. A discharge mechanism for discharging the paint in the storage cavity into the blending cavity and keeping the paint at a normal temperature to prevent the paint from drying out; the support body is provided with a sliding cavity opening to the right, and a support plate is slidably provided on the left wall of the sliding cavity. A vertical shaft for rotating and mixing paint is provided on the lower side of the support plate. A lifting mechanism capable of controlling the support plate to drive the vertical axis to move up and down is provided in the cavity. A fixed box is fixed on the top surface of the base, and a detection for detecting the color of the paint is fixed on the top surface of the fixed box. A turntable and a brush pen on the upper side of the detection plate, a pneumatic mechanism on the right side of the turntable that can control the brush pen to move downward to pick up paint, and the auxiliary body is provided with a cleaning mechanism A cleaning mechanism for the paint on the surface of the detection board is provided with a belt cavity in the top body, and a power mechanism capable of controlling the turntable to drive the brush pen to rotate and the cleaning mechanism to operate and clean is provided in the belt cavity.

2. The adjusting device capable of automatically reconciling paint detection color effects according to claim 1, wherein the discharge mechanism includes a control valve connected to a lower side of the storage cavity, and the lower side of the control valve communicates A discharge pipe is installed, the downward extension of the discharge pipe extends into the connection cavity, the right extension of the discharge pipe extends outside, and is located above the reconciliation cavity, and the bottom wall of the connection cavity is fixed. A heat preservation layer is provided, and a closed cover is installed on the upper side of the storage cavity.

3. The adjusting device capable of automatically reconciling the color detection effect of paint according to claim 1, wherein the lifting mechanism comprises a first motor fixed on a top wall of the sliding cavity, and the first motor A first screw is dynamically connected on the bottom surface, and the downward extending portion of the first screw penetrates the support plate and is rotationally matched with the bottom wall of the sliding cavity, and the first screw is screw-fitted with the support plate.

4. The adjusting device capable of automatically reconciling paint detection color effects according to claim 3, wherein a second motor is fixedly embedded in an inner wall of the support plate, and a top surface of the vertical shaft and the second shaft The motor is connected by power, and six groups of evenly arranged stirring rods are fixed on the outer periphery of the vertical shaft.

5. The adjusting device capable of automatically reconciling paint detection color effects according to claim 4, wherein a right side surface of the support body is hinged with a first hinge rod, and an opening is provided in the first hinge rod. A spring chamber facing to the right, a top surface of the support plate is articulated with a second articulated rod, a left side of the second articulated rod is fixedly provided with a straight rod, and the straight rod extends to the left to extend into the spring. Inside the cavity, a spring is fixedly installed between the left side surface of the straight rod and the left wall of the spring cavity.

6. The adjusting device capable of automatically reconciling paint detection color effects according to claim 1, wherein the pneumatic mechanism comprises a pneumatic slide rail fixedly mounted on the right side of the turntable, and the clamping block is slidably provided. On the right side of the pneumatic slide rail, the brush pen is clamped in the clamping block, a cylinder is fixed on the top surface of the turntable, and the cylinder and the clamping block are connected and installed between the cylinder and the clamping block. Outlet and inlet pipes.

7. The adjusting device capable of automatically reconciling the color effect of paint detection according to claim 1, wherein the cleaning mechanism comprises a connecting plate, and a second screw, a pushing rod and a fixing rod are fixed on the left side of the connecting plate. A cleaning rod, the second screw is located on the upper side of the push rod, the push rod is located on the upper side of the cleaning rod, a gear cavity, a drainage cavity and a through cavity are provided in the auxiliary body, and the gear cavity is located The upper side of the drainage chamber is located on the upper side of the through chamber. A cleaning liquid is provided in the drainage chamber. A screw sleeve is provided in the inner wall of the auxiliary body, and the screw sleeve is to the left. An extension portion extends into the gear cavity, the left extension portion of the second screw penetrates the screw sleeve, a left side surface of the screw sleeve is fixed with a square post, and the left extension portion tube passes through the In the auxiliary body, the square post is slidingly fitted to the inner wall of the auxiliary body, the second screw is threadedly fitted to the screw sleeve, and the push rod extends to the left into the drainage chamber, and A piston is fixed on the left side of the push rod, and the left side of the drainage chamber is connected with a safety device. Equipped with a damping valve, a nozzle is connected to the left side of the damping valve, the nozzle extends to the left to the outside and is located above the detection plate, and the cleaning rod extends to the left to extend into the In the through cavity, and a brush is fixed on the bottom surface of the cleaning rod, the through cavity is open on the left and right, and a jacket is fixed on the inner wall of the through cavity, and the cleaning rod runs through the jacket, the cleaning The rod is in sliding cooperation with the jacket.

8. The adjusting device capable of automatically reconciling paint detection color effects according to claim 7, characterized in that: a liquid storage chamber is opened at the rear side of the liquid discharge chamber, and a cleaning liquid is stored in the liquid storage chamber, and A check valve is connected to the front side of the liquid storage chamber, and a connection pipe is connected to the check valve and the liquid discharge chamber.

9. The adjusting device according to claim 1 or 7, wherein the power mechanism comprises a third motor embedded in the inner wall of the top body, and the third motor A motor shaft is dynamically connected to both the upper and lower sides of the motor. The bottom surface of the motor shaft on the lower side is fixedly connected to the top surface of the turntable, and the axially extending portion of the motor on the upper side projects into the belt cavity. A first pulley is fixed on the top surface of the motor shaft. A rotating shaft is rotatably provided on the bottom wall of the belt cavity. A second pulley is fixed on the top surface of the rotating shaft. A belt is installed between the wheel and the first pulley, and the downward extension part of the rotation axis penetrates the inner wall of the top body and the auxiliary body, and extends into the gear cavity, and the rotation shaft A first bevel gear is fixed on the bottom surface, and a second bevel gear is fixed on the outer periphery of the screw sleeve located in the gear cavity. The second bevel gear meshes with the first bevel gear.

10. The adjusting device capable of automatically reconciling the color detection effect of paint according to claim 1, characterized in that the fixed tank is provided with a waste liquid cavity with an upward opening.
